(19) United States
(12) Patent Application Publication
(10) Pub. No.: US 2012/0038132 A1
(43) Pub. Date: Feb. 16, 2012

(54) AIRBAG SYSTEM WITH A SEPARATE FIRING CHANNEL

(75) Inventor: Ulrich RICK, Braunweiler (DE)

(73) Assignee: GM GLOBAL TECHNOLOGY OPERATIONS LLC, Detroit, MI (US)

(21) Appl. No.: 13/207,107

(22) Filed: Aug. 10, 2011

(30) Foreign Application Priority Data
Aug. 12, 2010 (DE) 102010034114.2

(51) Int. Cl. B60R 21/16

(52) U.S. Cl. 280/728.2; 280/732

(57) ABSTRACT

An airbag system is provided with an airbag housing, a separate firing channel, and at least one latching connection for securing the airbag housing and firing channel to each other, which includes, but is not limited to a shaft with two opposing walls on the airbag housing or the firing channel, and a strap for introduction into the shaft, which is joined with the other airbag housing or firing channel, wherein the shaft and/or strap exhibits a first latching projection for engaging in back of a shoulder of the strap or shaft.

### CROSS-REFERENCE TO RELATED APPLICATION

This application claims priority to German Patent Application No. 102010034114.2, filed Aug. 12, 2010, which is incorporated herein by reference in its entirety.

### TECHNICAL FIELD

The technical field relates to an airbag system with an airbag housing and a separate firing channel, as well as to a motor vehicle with such an airbag system, in particular as a front passenger airbag.

### BACKGROUND

An airbag system with an airbag housing and separate firing channel are known from DE 101 15 803 A1, DE 10 2007 053 996 A1, as well as DE 297 23 034 U1. The airbag housing and firing channel are here separately attached to the body structure or dashboard in DE 101 15 803 A1, and only secured by a latch against the pressure impulse that arises upon activation, screwed together in DE 10 2007 053 996 A1, and fixed in place by bolts that engage into oblong holes in DE 297 23 034 U1. These connections between the airbag housing and separate firing channel can be improved, in particular with regard to assembly.

Therefore, at least one object is to provide an improved airbag system. In addition, other objects, desirable features and characteristics will become apparent from the subsequent summary and detailed description, and the appended claims, taken in conjunction with the accompanying drawings and this background.

### SUMMARY

An airbag system is provided that exhibits an airbag housing, which can entirely or partially incorporate in particular a gas generator and/or a folded airbag, along with a firing channel separate from the latter, i.e., designed as a separate component, for guiding the deploying airbag during its inflation. The firing channel can in particular exhibit a closed, preferably rectangular, cross section and/or at least partially overlap an outlet opening in the airbag housing or bluntly abut the latter with a slight gap. On its opposing face, the firing channel can be joined with or abut a dashboard when advantageously using the airbag system as a front passenger airbag. One or more latching connections are provided for securing the airbag housing and firing channel to each other.

At least one such latching connection exhibits a shaft with two opposing walls, which is arranged on the airbag housing or the firing channel. In particular, such a shaft can be integrally designed with the airbag housing or the firing channel. To this end, a wall of the airbag housing or firing channel can comprise one of the walls of the shaft in a preferred embodiment.

A strap used for introduction into this shaft is joined with the other airbag housing or firing channel. In particular, the strap can be designed as a single piece with the other airbag housing or firing channel for this purpose, for example cast. In particular, a shaft can hence be arranged on the airbag housing, preferably integrally designed with the latter, while a strap is joined with the firing channel for purposes of introduction into this shaft, preferably integrally designed with the latter. As an alternative, a shaft can be arranged on the firing channel, preferably be integrally designed with the latter, while a strap is joined with the airbag housing, preferably integrally designed with the latter. If two or more latching connections are provided for attaching the airbag housing and firing channel to each other, all shafts can similarly be arranged on the airbag housing and all straps on the firing channel, all shafts can be arranged on the firing channel and all straps on the airbag housing, or one or more shafts or one or more straps can be respectively arranged on both the airbag housing and firing channel.

The shaft and/or strap of a latching connection according to the invention has a first latching projection for engaging in back of a shoulder of the strap or shaft. A shoulder can here be defined in particular by a recess, a face or latch projection of the strap or shaft. In particular, then, the shaft of a latching connection can exhibit a latching projection, and the strap can exhibit a recess. Additionally or alternatively, the shaft can exhibit a shoulder, and the strap a latching projection. Similarly, the shaft and/or strap can also exhibit two or more latching projections and/or two or more shoulders, wherein latching projections can then be arranged in particular only on the shaft, only on the strap, or both on the shaft and strap. Two latching projections can engage in back of the same shoulder.

An airbag system with one or more, preferably structurally identical, latching connections can advantageously facilitate assembly, shorten assembly time and/or enhance the safety of the process and/or connection.

In an embodiment, one or more latching connections are provided on two or more sides of the airbag housing, which preferably exhibits a rectangular cross section or outline. In particular, one or more latching connections can be provided on opposing sides of the airbag housing, preferably on their longitudinal and/or transverse sides. In particular, this elevates the reliability of the attachment, and can advantageously better withstand torques.

Two or more latching connections are preferably provided at different heights of the airbag housing. In particular, latching connections provided on one side of the airbag housing can be situated at varying heights. Additionally or alternatively, latching connections provided on different, in particular mutually opposing, sides of the airbag can be arranged at different heights. All latching connections provided on the same side of the airbag housing can here be situated at the same height.

In an embodiment, a shaft of a latching connection according to the invention exhibits at least a partially closed edge. The shaft can here in particular exhibit a rectangular, closed cross section, which is formed by the two opposing walls, as well as two additional, also opposing walls. In particular if the two opposing walls are joined by means of a web, the shaft in the area of the web passing through a passage opening with a closed cross section can be formed only by the two opposing walls in the region adjacent thereto, i.e., have an open cross section. In this regard, such a shaft exhibits a closed edge in the direction of its extension or introduction, and an open cross section on the remaining area.

Additionally or alternatively, a recess can exhibit a closed edge. The recess can here in particular have a rectangular, closed cross section. A closed edge can improve the reliability of the attachment, while an open cross section facilitates elastic deformation. A latching connection is understood in particular as involving a process of engaging into a recess or engaging behind a shoulder or projection, wherein at least one of the two elements to be latched, meaning the strap and/or one or both opposing shaft walls, are elastically deformed for purposes of introduction, and resiliently rebound entirely or partially after introduced, thereby positively and/or frictionally resisting forces that would pull them out against the direction introduced. Therefore, a shaft wall or strap is elastically deformable for introducing the strap into the shaft in a preferred embodiment.

In order to enhance the reliability of the attachment, one or both shaft walls or the strap are reinforced in a preferred further development, in particular by one or more ribs, so that they are barely or not elastically deformed during introduction, while the respective other element, i.e., the strap or one of the two opposing shaft walls, is elastically deformed, so as to introduce a latching projection into the latching position.

An embodiment provides for a centering device for introducing a strap into a shaft. This centering device can consist in particular of an outer contour of the strap narrowing in the direction introduced and/or an inner contour of the shaft narrowing in the direction introduced. In a preferred further development, a strap of one or more latching connections according to the invention exhibits a corresponding centering extension on the face in the direction introduced, in particular a tip.

One or more latching connections according to the invention are preferably designed with a clearance, in particular in or opposite the direction introduced. On the one hand, a clearance can advantageously offset manufacturing and/or assembly tolerances. On the other hand, a clearance in the direction introduced, for example which can be provided by way of a frictional fixation with stroke reserve up to a positive stop of the latching projection, but also via an elastic deformation of the strap and/or shaft, allowing the firing channel to dip somewhat toward the airbag housing, so as to cause the firing channel and dashboard to descend if the front seat passenger hits a dashboard, thereby dissipating the impact energy.

An embodiment provides a latching device for blocking an elastic deformation by a shaft wall and/or a strap. In particular, such a latching device can encompass a separate component, which is introduced into a unilaterally open slot and there secured in place, preferably by way of a frictional or material bond, in particular through adhesive bonding, which is formed in the shaft wall or strap, and permits an elastic deformation of the two slot edges relative to each other without the separate component, thereby allowing a compression of the slit wall or strap.

### BRIEF DESCRIPTION OF THE DRAWINGS

The present invention will hereinafter be described in conjunction with the following drawing figures, wherein like numerals denote like elements, and:

FIG. 1 is the assembly of an airbag system according to an embodiment;

FIG. 2 is a cross section of the airbag system on FIG. 1 after assembled along the section line II-II therein;

FIG. 3 is a latching connection of an airbag system according to another embodiment as shown on FIG. 2;

FIG. 4 is a latching connection of an airbag system according to another embodiment as shown on FIG. 2;

FIG. 5 is a latching connection of an airbag system according to another embodiment as shown on FIG. 2; and

FIG. 6 is a latching connection of an airbag system according to another embodiment as shown on FIG. 1.

### DETAILED DESCRIPTION

The following detailed description is merely exemplary in nature and is not intended to limit application and uses. Furthermore, there is no intention to be bound by any theory presented in the preceding background or summary or the following detailed description.

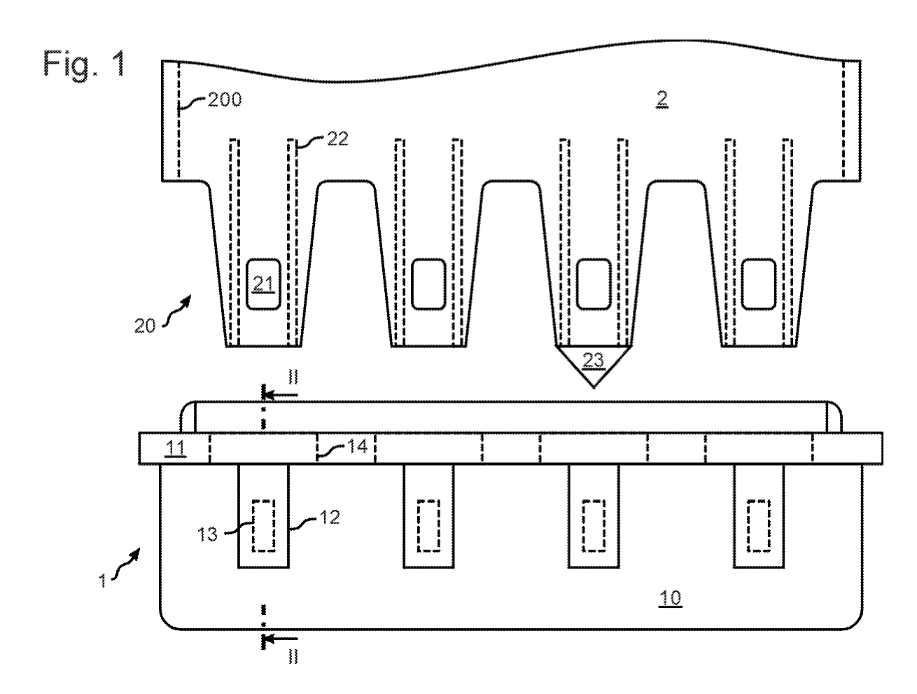

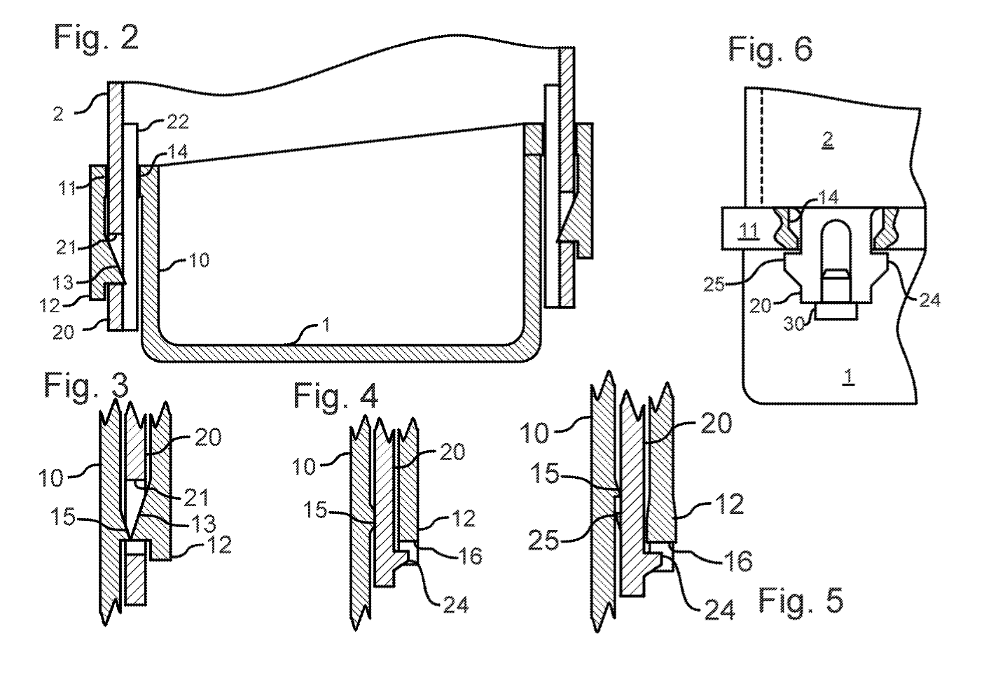

FIG. 1 shows the assembly of an airbag system according to an embodiment viewed on the longitudinal side. Visible at the bottom of FIG. 1 is an airbag housing 1, which accommodates a gas generator and folded airbag (not shown). As also discernible in cross section on FIG. 2 in particular, the airbag housing 1 exhibits two opposing longitudinal side walls 10 of varying height, whose upper edge has a web 11 integrally molded thereto.

Each longitudinal side of this web 11 incorporates several through openings, which exhibit a closed, rectangular cross section in a single plane perpendicular to the direction introduced (vertically downward at the bottom of FIG. 1 and FIG. 2). A dual wall 12 lying opposite the airbag housing wall 10 is molded to each through opening, and together with the respective through opening forms a shaft 14, which exhibits a closed cross section in the upper area of FIG. 1 and FIG. 2, and under that an open cross section comprised of the airbag housing and dual wall 10, 12.

A latching projection 13 denoted by a dashed line on FIG. 1 is molded onto the side of each wall 12 facing the airbag housing wall 10. As evident from FIG. 2, the latter (latching projection) exhibits a triangular cross section, wherein a lower side of the triangle viewed in the direction introduced runs transverse to the direction introduced, i.e., horizontally on FIG. 1 and FIG. 2. The latching projection 13 tapers opposite the direction introduced away from this bottom side of the triangle along a straight line, or in a modification not depicted, traces a curve, preferably concave or convex.

Situated above the airbag housing 1 is a separate firing channel 2. The latter exhibits straps 20 molded on in a single piece, wherein one respective latch 20 is flush with one of the shafts 14 described above in an assembly position. Each strap 20 is reinforced with two longitudinal ribs 22, and exhibits a recess 21 having a closed cross section. A dashed line is used on FIG. 1 to denote the transverse side walls 200 of the firing channel 2, which exhibits a rectangular outline. At its upper face on FIG. 1, 2, the firing channel no longer depicted in this area can be joined with a dashboard, for example latched, screwed or adhesively bonded.

A respective pointed centering extension 23 that together with an outer contour of the straps 20 narrowing in the direction introduced forms a centering region is arranged on one of the straps 20 for introduction into a shaft 14 of the lower, longitudinal side wall 10 of the airbag housing 1 discernible on FIG. 1, as well as on one of the straps 20 not visible on FIG. 1 for introduction into a shaft 14 of the higher longitudinal side wall 10 lying toward the back on FIG. 1.

When attaching the firing channel 2 to the airbag housing 1 as illustrated by the sequence on FIG. 1 to FIG. 2, the straps 20 are introduced into the shafts 14, during which the outer or dual walls 12 are elastically deformed when the introduced straps 20 reinforced by the ribs 22 press up against the latching projections 13. As soon as the final assembly position has been reached, the walls 12 return to their initial position, while the latching projections 13 extend into the recesses 21, i.e., engage the rear of the shoulder 21 formed by the latter, as may be gleaned from FIG. 2. As a consequence, the firing channel 2 is reliably latched with the airbag housing 1 in a simple manner.

In a cross section corresponding to the one on FIG. 2, FIG. 3 shows a latching connection according to another embodiment of the present invention. The same elements are labeled with the same reference numbers, so that only differences relative to the embodiment according to FIG. 1, FIG. 2 will be touched upon below, with reference otherwise being made to the specification, in particular to the airbag housing and firing channel, which apart from that are structurally identical.

Also molded on the airbag housing wall 10 on FIG. 3 is a (second) latching projection 15, which is congruently designed relative to the (first) latching projection 13 on the dual wall 12, but exhibits a smaller cross section and lies opposite the (first) latching projection 13. Both latching projections 13, 15 extend into the same recess 21 in the assembly position.

As evident from FIG. 3, the latter is longer in the direction introduced than the latching projections 13, 15, so that the latching connection exhibits a clearance in the assembly position opposite the direction introduced. A clearance is also created in the direction introduced, since the strap 20 can run up against the latching projection 13 and elastically force the outer or dual wall 12 to the outside, thereby enabling the firing channel 2 to dip toward the airbag housing 1 (downwardly on FIG. 3). In a modification not depicted, the clearance can also be provided only in or opposite the direction introduced.

In a cross section corresponding to the one FIG. 2, FIG. 3, FIG. 4 shows a latching connection according to another embodiment. The same elements are again labeled with the same reference numbers, so that only differences relative to the embodiment according to FIG. 1 to FIG. 3 will again be touched upon below, with reference otherwise being made to the specification, in particular to the airbag housing and firing channel, which apart from that are structurally identical.

On FIG. 4, a latching projection 24 is molded onto the strap 20, and in the assembly position engages in back of a shoulder 16 formed by a face of the dual wall 12, with clearance. The dual wall 12 proceeds from this face and continues in the direction introduced on either side of the latching projection 24 or shoulder 16, thereby forming a U-shaped recess with an open cross section.

Arranged on the airbag housing wall 10 is a projection 15, which forces the strap 20 against the dual wall 12 in the assembly position. Such a projection is also referred to more generally as a (second) latching projection, since it supports the latching of the (first) latching projection 24 with the shoulder 16.

In this embodiment, the strap 20 has no ribs, and can thus elastically deform while being introduced, in particular toward the dual wall 12 as it passes the latching projection 15, and then back again after passing, and return to the dual wall 12 again upon reaching the shoulder 16.

In a cross section corresponding to the one on FIG. 2 to FIG. 4, FIG. 5 shows a latching connection according to another embodiment. The same elements are again labeled with the same reference numbers, so that only differences relative to the embodiment according to FIG. 1 to FIG. 3 will again be touched upon below, with reference otherwise being made to the specification, in particular to the airbag housing and firing channel, which apart from that are structurally identical.

On FIG. 5, a (second) latching projection 25 is also arranged on the strap 20, and in the assembly position engages the rear of the (second) latching projection 15 with clearance, thereby positively countering any withdrawal against the direction introduced. While being introduced, the strap 20 is exposed to an elastic deformation that is reversible in the assembly position, and forced away from the airbag housing wall 10, which in turn does the same to the dual wall 12, to return back to the undeformed state depicted on FIG. 5 during the latching process.

In a side view corresponding to the one on FIG. 1, FIG. 6 shows a latching connection according to another embodiment. The same elements are again labeled with the same reference numbers, so that only differences relative to the embodiment according to FIG. 1 to FIG. 5 will again be touched upon below, with reference otherwise being made to the specification, in particular to the airbag housing and firing channel, which apart from that are structurally identical.

On FIG. 6, the respectively front face of the straps 20 in the direction introduced exhibit a U-shaped slot, which while being introduced allows an elastic deformation of the two slot edges or the legs of the strap 20 they form relative to each other. In order to force this deformation while at the same time providing a centering means, the shaft 14, here formed only by the through opening in the web 11 closed along its edge, as well as the strap 20 with its two latching projections 24, 25 each form a contour that tapers in the direction introduced on their two opposing legs. To this end, the web 11 is shown partially cut in the area of the shaft 14 on FIG. 6.

After the legs of the strap 20 have been introduced through the shaft, they again spring back into their undeformed state depicted on FIG. 6, in which their two latching projections 24, 25 each engage a shoulder from the back with clearance, which in this embodiment is defined by the web 11.

In order to prevent a deflection, a latching means in the form of a separate component 30 is subsequently introduced into the slot, and there fixed into place, for example by way of a frictional or material bond. In a preferred further development, the latter can again be removed, in order to then elastically press together the two legs of the strap 20, and in this state remove them from the shaft 14 against the direction introduced, in order to again detach the firing channel 2 from the airbag housing 1.

The latching connections on FIG. 3 to FIG. 6 are each designed in or against the direction introduced, with clearance. In modifications not depicted, the latching connections can also be configured in other directions with clearance, in particular transverse to the direction introduced, but in like measure at least essentially without clearance.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An airbag system, comprising:
an airbag housing;
a separate firing channel;
a latching connection configured to secure the airbag housing and the firing channel;
a shaft with two opposing walls on the airbag housing or the firing channel;
a strap configured for introduction into the shaft that is joined with the other of the airbag housing or the firing channel; and
a first latching projection configured to engag in back of a shoulder of the strap or the shaft.

2. The airbag system according to claim 1, wherein the latching connection is positioned on at least two, in particular opposing, sides of the airbag housing.

3. The airbag system according to claim 1, further comprising two latching connections at a varying height of the airbag housing.

4. The airbag system according to claim 1, further comprising a second latching projection configured to engage in back of the shoulder of the strap or the shaft.

5. The airbag system according to claim 1, further comprising the shoulder defined by a recess, a face or a latching projection.

6. The airbag system according to claim 1, further comprising a closed edge at least along a portion of an extending direction.

7. The airbag system according to claim 1, a shaft wall that is elastically deformable and configured to introduce the strap into the shaft.

8. The airbag system according to claim 7, wherein the shaft wall is reinforced by a rib.

9. The airbag system according to claim 1, further comprising a centering configured to introduce the strap into the shaft.

10. The airbag system according to claim 1, wherein the latching connection comprises a clearance.

11. The airbag system according to claim 7, further comprising a latching configured to block an elastic deformation of the shaft wall.

12. A motor vehicle, comprising:
a dashboard;
an airbag system comprising a fireing channnel joined with th dashboard, the airbag system further comprising:
an airbag housing;
a separate firing channel;
a latching connection configured to secure the airbag housing and the firing channel;
a shaft with two opposing walls on the airbag housing or the firing channel;
a strap configured for introduction into the shaft that is joined with the other of the airbag housing or the firing channel; and
a first latching projection configured to engag in back of a shoulder of the strap or the shaft.

13. The motor vehicle according to claim 12, further comprising wherein the latching connection is positioned on at least two, in particular opposing, sides of the airbag housing.

14. The motor vehicle according to claim 12, further comprising two latching connections at a varying height of the airbag housing.

15. The motor vehicle according to claim 12, further comprising a second latching projection configured to engage in back of the shoulder of the strap or the shaft.

16. The motor vehicle according to claim 12, further comprising the shoulder defined by a recess, a face or a latching projection.

17. The motor vehicle according to claim 12, further comprising a closed edge at least along a portion of an extending direction.

18. The motor vehicle according to claim 12, a shaft wall that is elastically deformable and configured to introduce the strap into the shaft.

19. The motor vehicle according to claim 18, wherein the shaft wall is reinforced by a rib.

20. The motor vehicle according to claim 12, further comprising a centering configured to introduce the strap into the shaft.
